(19) United States
(12) Patent Application Publication
(10) Pub. No.: US 2025/0263057 A1
(43) Pub. Date: Aug. 21, 2025

(54) METHOD AND APPARATUS FOR OPERATING AN ELECTROMECHANICAL BRAKING DEVICE, BRAKING DEVICE AND BRAKING SYSTEM

(71) Applicant: Robert Bosch GmbH, Stuttgart (DE)

(72) Inventors: Laszlo Boros, Ludwigsburg (DE); Rainer Walter, Pleidelsheim (DE); Simon Peter, Weil Der Stadt (DE); Xi Nowak, Bisingen (DE)

(21) Appl. No.: 19/034,999

(22) Filed: Jan. 23, 2025

(30) Foreign Application Priority Data
Feb. 15, 2024 (DE) 10 2024 201 398.6

(51) Int. Cl. B60T 17/22; B60T 13/74; F16D 127/06

(52) U.S. Cl. CPC B60T 17/22; B60T 13/746; B60T 2270/406; F16D 2127/06

(57) ABSTRACT

A method for detecting a malfunction of an electromechanical braking device of a braking system for a motor vehicle. The braking device has at least one controllable electric motor and at least one actuator element that can be displaced by the electric motor, wherein in the idle state of the braking device the actuator element has a clearance in the actuation direction. For a test procedure, the electric motor is controlled such that the actuator element is displaced only within the clearance, and the presence of a malfunction is ascertained according to at least one operating parameter of the electric motor detected in the process.

### CROSS REFERENCE

The present application claims the benefit under 35 U.S.C. § 119 of German Patent Application No. DE 10 2024 201 398.6 filed on Feb. 15, 2024, which is expressly incorporated herein by reference in its entirety.

### FIELD

The present invention relates to a method for detecting a malfunction of an electromechanical braking device of a braking system for a motor vehicle, which braking device has at least one controllable electric motor and at least one actuator element that can be displaced by the electric motor, wherein in the idle state of the braking device the actuator element has a clearance in the actuation direction.

Furthermore, the present invention relates to an apparatus for operating an electromechanical braking device as described above, and to an electromechanical braking device comprising such an apparatus and a braking system that has at least one such electromechanical braking device.

### BACKGROUND INFORMATION

Methods and braking devices of the general type mentioned at the outset are described in the related art. While with conventional hydraulic braking systems the functionality of the braking system can be tested by monitoring the hydraulic pressure in the braking system by means of a pressure sensor, this is more complicated with electromechanical braking systems. If the transmission of power is carried out purely mechanically, i.e. without hydraulics, a pressure sensor normally used in braking systems can no longer be used. While with hydraulic braking systems, inlet valves are closed on the hydraulic wheel brakes of the test system during a test procedure for detecting a malfunction, so that no braking torque is generated on the wheel brakes due to the pressure build-up, this is not possible with electromechanical braking systems, which act directly on the particular mechanical wheel.

Typically, braking devices have a clearance that the actuator or an actuator element must overcome before a braking force or braking torque can be generated. The clearance is understood in particular to mean the distance between a brake shoe or brake pad and a brake disk, and thus the distance that the actuator element must overcome before a braking force can be generated. In particular, the clearance in the idle state of the braking device serves to reduce wear on the braking device by preventing a sliding contact within the braking device, in particular between the brake shoe and the brake disk, when the braking device is not actuated. Depending on the application, the clearance can be selected to be larger or smaller in order to avoid signs of wear.

### SUMMARY

A method according to the present invention may have the advantage that a malfunction of an electromechanical braking device can be detected even without braking torque or braking force build-up. For this purpose, an example embodiment of the present invention provides that in a test procedure, the electric motor is controlled such that the actuator element is only displaced within the clearance, and that the presence of a malfunction is ascertained according to an operating parameter of the electric motor detected in the process. In particular, a motor current and/or a motor voltage of the electric motor are continuously monitored as operating parameters and a malfunction of the braking device is ascertained based on the detected values. As long as the actuator element is only displaced within its clearance, it is ensured that no braking torque or braking force is exerted by the braking device. While the electric motor is being actuated, in particular in order to overcome the clearance, i.e., to move the actuator element in the actuation direction, but without overcoming the clearance, the at least one operating parameter of the electric motor is monitored and, in particular, tested for abnormalities. As a result, the malfunction of the braking device can be advantageously recognized without generating any braking torque.

According to a preferred further development of the present invention, a malfunction of the electric motor is determined when a deviation of the operating parameter from an expected operating parameter is detected, in particular when an unexpectedly high motor current and/or an unexpectedly high motor voltage is detected. If, for example, the motor current unexpectedly increases above a predefined limit value and/or at a surprisingly early point in time or after a surprisingly short distance, it can be identified that the function of the braking device is impaired.

According to a further example embodiment of the present invention, it is preferably provided that a malfunction is determined when an unexpectedly absent change in operating parameters is detected, in particular when there is no increase in motor current and/or no increase in motor voltage. In this case, the braking device is tested to determine whether any expected response at all occurs in the braking device due to the control of the electric motor. If, for example, it is recognized that the actuator element is not displaced despite the control of the electric motor, a malfunction is likewise determined.

When performing the method of the present invention, according to an example embodiment, it is preferably provided that the electric motor is controlled such that an inertial force, in particular of the braking device or the electric motor, can be detected as a counter-torque. The inertial force of the electric motor, in particular of its rotor, is thus used to test the functionality of the electric motor. Inertial force results, on the one hand, from the mass of a rotor of the electric motor and, on the other hand, from the magnetic forces that act between the rotor and stator and can exert an inhibiting torque on the rotor. The inertial force is also influenced by the mass of the actuator element itself and by an optional gear mechanism between the electric motor and actuator element. The counter-torque resulting from the inertial force is detected by the change in operating parameters, in particular by an increase in motor current. Thus, the detected counter-torque is advantageously compared with an expected counter-torque, which was ascertained by previous calculations and/or tests or by a test procedure on another braking device of the braking system, in order to identify whether the braking device, in particular the electric motor, is functioning properly.

According to an example embodiment of the present invention, preferably, the electric motor is controlled at a frequency or dynamic that is not sufficient to overcome the inertial force. As a result, it is ensured that the electric motor is not set into a rotational movement and the actuator element is displaced to such an extent that the clearance is overcome. Due to the control at a frequency or dynamic, it is ensured that the electric motor is only briefly controlled to generate a torque that is lower than the inertial force of the braking device, so that the electric motor does not start up.

According to an alternative embodiment of the present invention, the electric motor is preferably controlled to operate in the opposite direction to the actuation direction. As a result, it is ensured that the clearance cannot be overcome by the actuator element. Instead, the electric motor is controlled in the opposite direction, so that the actuator element is moved in particular to an end position remote from the actuating position. In particular, an end stop is assigned to the actuator element, up to which stop the actuator element can be retracted as far as possible. The end stop ensures, for example, a defined starting position for the actuator element, as a result of which calibration of the actuator element is made possible even during the operation of the braking device or a motor vehicle equipped with the braking device. As a result of the actuator element being moved in the direction of the stop by the electric motor, the functional test of the electric motor is likewise ensured without the generation of braking torque. As soon as the actuator element hits the end stop, the motor current of the electric motor increases abruptly. Thus, it can be reliably identified that, if the change in operating parameters corresponds to the expected change in operating parameters, the actuator element has reached the end stop and the electric motor or the braking device comprising the actuator element is functioning correctly. In particular, if the expected change in operating parameters does not occur, it is identified that there is a malfunction in the braking device.

According to a further example embodiment of the present invention, a parking brake, which blocks the braking device, is preferably activated prior to the control of the electric motor. Corresponding parking brakes are conventional. These engage mechanically in the flow of force from the electric motor to the actuator element, for example by retracting a locking element into the gear mechanism. Due to the retracted locking element, it is ensured in the de-energized state that any braking force once generated is maintained. As a result, a parking braking can be provided in an energy-saving manner. Due to the blocking of the braking device prior to the control of the electric motor, i.e., when the braking device is in the idle state, the electric motor can be controlled to move the actuator element in the actuation direction, without overcoming the clearance. Instead, the force provided by the electric motor or the torque provided acts directly against the parking brake, which prevents the displacement of the actuator element. Thus, in this case as well, a comparison of the detected operating parameter(s) of the electric motor with expected operating parameters, which are to be expected when the parking brake is controlled, is made possible in order to recognize a malfunction of the braking device.

Preferably, according to an example embodiment of the present invention, the braking system has a plurality of electromechanical braking devices, wherein the braking devices are in each case preferably tested for a malfunction one after the other in a sequential manner. As a result, it is ensured that the activation of one braking device does not influence the behavior of one of the other braking devices. Preferably, the detected operating parameters of braking devices, which are each assigned to an axle of the motor vehicle, are compared with one another. As a result, the comparison with reference parameters which were previously detected, i.e. calculated and/or measured, can be omitted. Instead, a plausibility check of the detected operating parameters of the braking devices against one another is preferably carried out.

According to an example embodiment of the present invention, preferably, a friction, a hysteresis between the forward and reverse movement of the actuator element, a gear backlash, a gear mechanism and/or a caliper stiffness, a gear efficiency, a response time, a dynamic, an acceleration, a motor constant, at least one electrical resistance and/or the state of a power electronics of the electric motor are ascertained as operating parameters as an alternative or in addition to the motor current or motor voltage, and are used as the basis for the functional test. As a result, gear mechanism faults, such as a damaged gear tooth or a ball ramp, which can, for example, manifest as vibrations in the current or position signal of the braking device, can also be ascertained.

According to an example embodiment of the present invention, preferably, the method is performed at regular intervals and/or after each startup of the braking system. In particular, the method is performed if a driving situation is suitable, such as if dynamic heavy braking is required. In this case, however, driving is only performed if the control of the particular braking device cannot have a negative effect on the driving operation of the motor vehicle and, in particular, cannot be felt by the occupants of the motor vehicle.

An apparatus according to example embodiment of the present has a control unit that is specifically configured to carry out the method according to the present invention. This results in the advantages already mentioned above.

A braking device according to an example embodiment of the present invention includes the apparatus according to the present invention. This results in the advantages already mentioned above.

A braking system according to an example embodiment of the present invention has a plurality of the above-mentioned braking devices, which are each assigned an apparatus according to the present invention or which together are assigned a common apparatus according to the present invention. This results in the advantages already mentioned above.

Further advantages and preferred features and combinations of features result in particular from the disclosure herein. The present invention is explained in more detail below with reference to the figures.

### BRIEF DESCRIPTION OF THE DRAWINGS

FIG. 1 shows a motor vehicle having an advantageous braking system in a simplified plan view, according to an example embodiment of the present invention.

FIG. 2 shows a braking device of the braking system in a schematic representation, according to an example embodiment of the present invention.

FIG. 3 shows a flowchart for explaining the advantageous method for operating the braking system, according to an example embodiment of the present invention.

### DETAILED DESCRIPTION OF EXAMPLE EMBODIMENTS

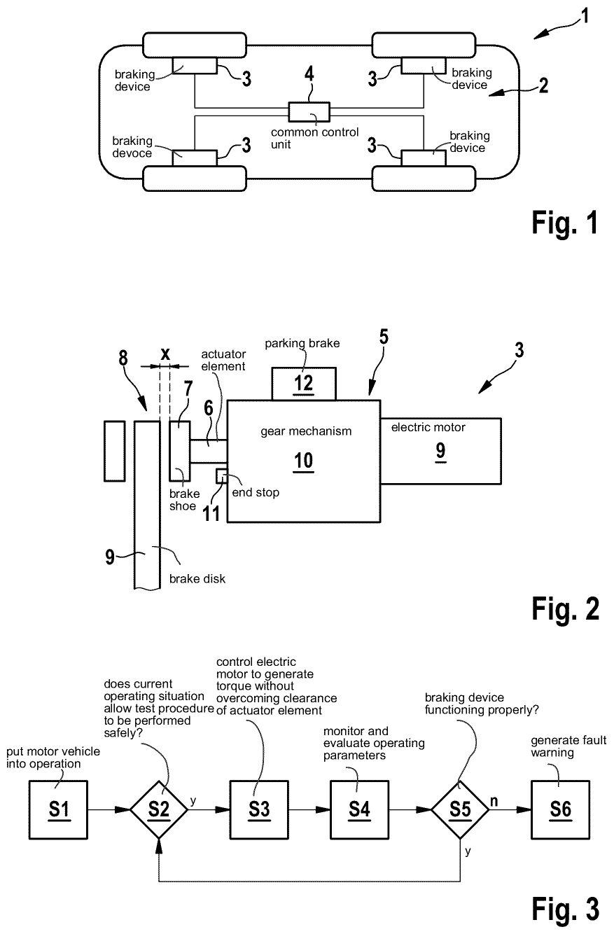

FIG. 1 shows, in a simplified representation, a motor vehicle 1 having an advantageous braking system 2. The braking system 2 has a braking device 3 for each wheel of the motor vehicle 1, wherein the braking devices 3 are operated by a common control unit 4. The control unit 4 controls the braking devices 3 in particular according to a braking request predefined by a driver of the motor vehicle or a braking request from an autonomous driving system of the motor vehicle 1, in order to decelerate the motor vehicle 1 in accordance with the braking request. In the present case, the braking devices 3 are designed as electromechanical braking devices 3.

FIG. 2 shows, in a schematic representation, an exemplary embodiment of one of the braking devices 3. Each of the electromechanical braking devices 3 has an actuator 5 and an actuator element 6 that can be displaced by the actuator 5. In the present case, the actuator element 6 is designed as a pressure piston, which is connected to a brake shoe 7 or brake pad of a brake caliper 8 that has two brake shoes 7. Between the brake shoes 7, a brake disk 9 is guided, which is non-rotatably connected to the wheel of the motor vehicle 1 assigned to it. If the brake shoe 7 is shifted against the brake disk 9 by the actuator element 6, the brake disk 9 is braced between the two brake shoes, thereby generating a braking torque on the brake disk, which torque acts on the assigned wheel and thus decelerates the motor vehicle 1.

According to the present exemplary embodiment, the actuator 5 has a controllable electric motor 9, which is connected to the actuator element 6 for its displacement via an advantageous gear mechanism 10. The actuator element 6 is held so that it can be displaced longitudinally in particular. In particular, the gear mechanism 10 is designed to convert a rotational movement of a rotor of the electric motor 9 into the translational movement of the actuator element 6.

In order to test the functionality of the braking devices 3, the method described below with reference to FIG. 3 is carried out. FIG. 3 shows a flowchart in which the main method steps are shown in simplified form.

In a first step S1, the motor vehicle is put into operation, thus activating the braking system 2. A subsequent query S2 tests whether the current operating situation of the motor vehicle 1 allows the test procedure to be performed safely. In particular, it is tested whether or not the performance of the test procedure has an effect on the vehicle's behavior. The test procedure is only authorized if the performance of the test procedure does not negatively affect the operating behavior of the motor vehicle 1. It is also tested when the test procedure was last performed or whether a predefined time period has been exceeded since the last test procedure was performed and whether a new test procedure is required. Optionally, it is tested whether there is a dynamic braking process due to a braking torque request. If this is the case, the test procedure can likewise be performed without the test procedure having any effect on driving operation or being perceptible by a driver of the motor vehicle 1.

If the conditions necessary for performing the test procedure are fulfilled (y), the test procedure is started in the next step S3. For this purpose, the electric motor 9 is controlled to generate a torque, without, however, overcoming the clearance of the actuator element 6.

In the idle state, the brake shoe 7 is at a distance from the brake disk 9. This distance x is referred to as the clearance. Only if the clearance has been overcome and the brake shoe 7 touches the brake disk 9 can a braking torque or braking force be generated. The clearance serves in particular to prevent friction between the brake disk 9 and the brake shoe 7 or the brake pad during driving operation if there is no braking request. Due to the advantageous control of the electric motor in step S3, it is ensured that no braking torque or braking force is generated during the test procedure that could impair driving operation.

In the subsequent step S4, operating parameters, in particular of the electric motor, are monitored and evaluated in response to its control.

In the subsequent step S5, according to at least one of the ascertained operating parameters, it is identified whether the braking device 3 is functioning properly, or whether there is a malfunction. For example, the selected operating parameter is compared with a comparison value or reference value that has been calculated and/or measured or ascertained. Optionally, the selected operating parameter is compared with an equivalent operating parameter of another of the braking devices 3, in order to test whether one of the two braking devices 3 is malfunctioning.

If it is identified in step S5 that there is no malfunction (y), the method is restarted or repeated with step S2. However, if it is identified that a malfunction is present (n), a fault warning is generated and output in the subsequent step S6. For example, the driver is informed that one of the braking devices 3 has a malfunction. Optionally, limp-home mode can be configured for the faulty braking device 3.

The method described has the advantage that a functional test is also possible without the presence of a pressure or force sensor, and without a braking force being generated on one of the wheels of the motor vehicle. For the control of the electric motor 9 without overcoming the clearance, one of the variants described below is used in particular:

According to a first variant, the motor inertia of the electric motor 9 is utilized. Due to the dynamic control and/or control of the motor frequency, it is ensured that the motor inertia is not overcome, thereby preventing displacement of the actuator element 6. The motor inertia results in particular from the mass of the rotor of the electric motor 9 to be started and from any magnetic forces acting in the electric motor 9, and optionally from the mass of the gear mechanism 10 to be driven and the actuator element 6 itself.

In a further variant, the actuator element 6 is moved in the opposite direction to the actuating direction by the electric motor 9, in the direction of an end stop 11, which prevents further displacement of the actuator element 6, in particular the brake shoe 7. As a result, overcoming the clearance is likewise effectively prevented, and nevertheless the functionality of the electric motor 9 and the braking device 3 as a whole is reliably tested.

According to a third variant, it is provided that the actuator 5, in particular the gear mechanism 10, is assigned a parking brake 12, which engages mechanically or in a positive-locking manner in the gear mechanism 10 upon each activation, in order to block it. Before the electric motor 9 is controlled, the parking brake 12 is activated so that the gear mechanism 10 is blocked. If the electric motor 9 is then controlled, the actuator element 6 is prevented from overcoming the clearance. Instead, the electric motor 9 works against the locking mechanism of the parking brake 12.

If it is nevertheless necessary to press a brake pad 7 or the brake shoe against the brake disk 9 during the test procedure, it is ensured that this happens only very lightly or with little pressure, or with a low braking torque.

Preferably, the malfunction is not recognized due to a deviation of a sensor actual value from a sensor target value, but rather due to a parameter deviation that is identified, in particular, using a model-based approach. For example, the selected operating parameter of the particular braking device 3 is compared with the same operating parameter of another of the braking devices 3, in order to test whether the braking devices work the same or differently, and to recognize whether there is a malfunction. To ensure that the test procedures of the braking devices 3 do not influence one another, they are carried out one after the other, in particular with a slight temporal offset.

Due to the signals, typically already present in the braking system 2, in relation to the operating current, an operating voltage, a motor position, which is shown for example as the angle of rotation of the rotor, and possibly a motor temperature, the following operating parameters of the electric motor 9 are preferably taken into account in the fault diagnosis: friction, hysteresis between forward and reverse travel, gear backlash, gear mechanism and caliper stiffness, gear efficiency, response time, time constant, dynamics, motor acceleration, motor constant, electrical resistances and/or state of the power electronics, in particular a bridge circuit of the power electronics. In addition, gear mechanism faults, such as tooth damage, a ball ramp or the like, are ascertained according to vibrations in the current or position signal of the electric motor 10.

The test procedure is performed in particular whenever a driving situation is suitable, for example when dynamically strong braking occurs due to a corresponding braking torque request. Here, a test is carried out in braking mode, in which the clearance x must be overcome. In this case, however, an additional or separate test procedure can be omitted.

Due to the present method, however, active control of the electric motor 9 is performed in a state of the braking system 2 in which a braking request is not present, so that the operating behavior of the motor vehicle 1 cannot be impaired by the test procedure. Preferably, the test procedure is performed when the motor vehicle 1 is started up or if the braking devices 3 have not been used for a predefined period of time. A combination of the test procedures, one during braking and one outside of a braking situation, is also possible. It is also possible to add the test procedure to a normal braking actuation, i.e., when a braking request is present, in which test procedure, during the release process of the braking devices 3, if the actuator element 6 is moved in the opposite direction to the actuating direction, a sine wave is added to the target values, and the response in the operating parameters is monitored.

A sudden drift of an operating parameter on one of the braking devices indicates a malfunction. Slower or smaller deviations, on the other hand, tend to indicate signs of wear and are therefore preferably compensated for in the control.

What is claimed is:

1. A method for detecting a malfunction of an electromechanical braking device of a braking system for a motor vehicle, the braking device having at least one controllable electric motor and at least one actuator element that can be displaced by the electric motor, wherein in an idle state of the braking device, the actuator element has a clearance in a actuation direction, the method comprising the following steps:
for a test procedure:
controlling the electric motor such that the actuator element is displaced only within the clearance; and
ascertaining a presence of a malfunction according to at least one operating parameter of the electric motor detected during the controlling.

2. The method according to claim 1, wherein a malfunction is determined when a deviation of the operating parameter from an expected operating parameter of the electric motor is detected.

3. The method according to claim 1, wherein a malfunction is determined when an unexpectedly absent change in operating parameters is detected.

4. The method according to claim 1, wherein the electric motor is controlled such that an inertial force can be detected as a counter-torque.

5. The method according to claim 4, wherein the electric motor is controlled at a frequency or dynamic that is not sufficient to overcome the inertial force.

6. The method according to claim 1, wherein the electric motor is controlled to operate in an opposite direction to the actuating direction.

7. The method according to claim 1, wherein a parking brake, which blocks the braking device, is activated prior to the control of the electric motor.

8. The method according to claim 1, wherein the braking system has a plurality of electromechanical braking devices, wherein the braking devices each tested for a malfunction one after the other in a sequential manner.

9. The method according to claim 1, wherein the test procedures performed at regular intervals and/or after each startup of the braking system.

10. An apparatus for operating an electromechanical braking device of a braking system for a motor vehicle, the braking device having at least one controllable electric motor and at least one actuator element that can be displaced by the electric motor, wherein in an idle state of the braking device the actuator element has a clearance in the actuation direction, the apparatus comprising:
a control unit specially configured to perform, for a test procedure:
controlling the electric motor such that the actuator element is displaced only within the clearance; and
ascertaining a presence of a malfunction according to at least one operating parameter of the electric motor detected during the controlling.

11. An electromechanical braking device for a braking system of a motor vehicle, the braking device comprising:
at least one controllable electric motor;
at least one actuator element that can be displaced by the electric motor, wherein in the idle state of the braking device the actuator element has a clearance in an actuation direction; and
a control unit specially configured to perform, for a test procedure:
controlling the electric motor such that the actuator element is displaced only within the clearance; and
ascertaining a presence of a malfunction according to at least one operating parameter of the electric motor detected during the controlling.

12. A braking system for a motor vehicle, comprising:
a plurality of electromechanical braking devices, each of the braking devices including:
at least one controllable electric motor; and
at least one actuator element that can be displaced by the electric motor, wherein in the idle state of the braking device the actuator element has a clearance in an actuation direction;
wherein each of the braking devices is assigned a respective apparatus or together are assigned a common apparatus according, each respective apparatus or the common apparatus including:
a control unit specially configured to perform, for a test procedure:
controlling the electric motor such that the actuator element is displaced only within the clearance, and
ascertaining a presence of a malfunction according to at least one operating parameter of the electric motor detected during the controlling.
